(19) United States
(12) Patent Application Publication
(10) Pub. No.: US 2025/0213007 A1
(43) Pub. Date: Jul. 3, 2025

(54) PRODUCTION OF A SUBSTRUCTURE FOR FOOTWEAR

(71) Applicant: Berkinstock IP Gmbh, Linz am Rhein (DE)

(72) Inventors: Christoph Manfred Ruland, Kolh (DE); Markus Baum, Idstein (DE); Cansu Elman, Kolh (DE)

(21) Appl. No.: 18/850,581

(22) PCT Filed: Apr. 3, 2023
(86) PCT No.: PCT/EP2023/058621

§ 371 Date: Sep. 25, 2024

(30) Foreign Application Priority Data
Apr. 14, 2022 (DE) 20 2022 102 024.8

(51) Int. Cl. A43D 25/20; A43B 13/06; A43B 13/12

(52) U.S. Cl. CPC A43D 25/20; A43B 13/06; A43B 13/12

(57) ABSTRACT

A substructure for footwear can be produced. An inner half-shell of an intermediate layer forms a foot support and a lower, adhesion-promoting layer is produced by heating a mass, pressing the heated mass with the adhesion-promoting layer to form the inner half-shell which is then cooled. A sole area is foamed without demolding the half-shell in a mold part, wherein a press die is introduced into the mold part for pressing the mass with the adhesion-promoting layer. After removal of the press die a mold cavity is placed sealingly on the mold part, so that a cavity in the form of the sole region remains between the lower, adhesion-promoting layer and the mold cavity, into which a plastic is injected or foamed.

### CROSS-REFERENCE TO RELATED APPLICATIONS

This patent application is filed under 35 U.S.C. § 371 as a national stage of, and as such claims priority to, International Patent Application No. PCT/EP2023/058621, filed on Apr. 3, 2023, which claims priority to and all advantages of German Patent Application No. DE 20 2022 102 024.8 filed on Apr. 14, 2022, each of the foregoing applications being incorporated herein by reference in their entireties.

### BACKGROUND

A known method for producing a substructure for footwear articles comprises:
Production of an inner half-shell of an intermediate layer forming a footrest and a lower, adhesion-promoting layer by
   heating a mass as the starting material for forming the intermediate layer,
   pressing the heated mass positioned and distributed on the lower, adhesion-promoting layer with the lower, adhesion-promoting layer to form an inner half-shell in a mold,
   actively or passively cooling the inner half-shell,
   production of a lower sole section by foaming or spraying the lower sole section onto the inner half-shell on the side of the lower, adhesion-promoting layer in a mold, and
   demolding the substructure from the mold.

Footwear articles within the meaning of the present application are to be under-stood as all forms of footwear articles which are suitable for the implementation of the method according to the disclosure, i.e. which comprise a substructure having the proper intermediate layer and a lower sole section molded onto the substructure from below. These are preferably, but not necessarily, men's and women's shoes, also as sports shoes, could be other footwear products, such as sandals, slippers or mules. All these products are referred to in this application as “footwear”.

The lower sole section of footwear referred to herein comprises a half-shell which constitutes the inner support area for the wearer's foot. Usually, a lower sole section is injection-molded onto the bottom side of this half-shell using a plastic that foams up in an injection mold, with the half-shell and lower sole section then constituting the so-called substructure of the footwear. In most cases, the lower sole section is produced from a polyurethane (PU) with a foaming agent added in the plasticized state. In this case, a foam structure is selected that is integrally compacted in the region of the actual tread and the edge areas, resulting in a light, elastic sole section with sufficient mechanical strength on the bottom side and in the edge area.

In many footwear products, the footbed is ergonomically molded and adapted to the contour of the foot. This is achieved by means of a mass that can be molded during production and later solidifies to form an elastic body, preferably made of a material that is breathable and moisture-permeable after solidification and during wear, as durable and elastic as possible. Furthermore, a natural material should be used if possible. This layer of the substructure is referred to as the intermediate layer in the context of the present application.

A cover can be applied to the intermediate layer, which can also create a quality-enhancing impression, comprise additional, for example sweat-absorbing and/or resilient properties or also serve as a carrier for printed information, such as the manufacturer's name, model name or parameters of the footwear. During the production of the footwear, the substructure described above must now be permanently bonded to the lower sole section. This can be done by molding the material of the sole area to the substructure or by gluing it.

A substructure for footwear, as described above, and a method for producing it in the manner described above are generally known, for example, from the production of sports shoes or sandals. However, one disadvantage of simply gluing or molding the sole area to the substructure is that it is often desirable to use a material for the intermediate layer which, although very comfortable and favorable for the wearer due to its properties, is difficult to bond to a foamed plastic. Further, during the wearing of the footwear, especially in the case of sports footwear, the front region of the intermediate layer and the sole region is exposed to a constant, comparatively large mechanical load, in particular a bending load and a deformation load.

### SUMMARY

The present disclosure relates to a method for producing a substructure for footwear. The disclosure also relates to an article of footwear with such a substructure, which is produced according to the new method, and to a machine for carrying out and implementing this method.

Described herein is a method for the production of a substructure of a footwear article which enables the substructure of the footwear article to be produced easily and durably at a low cost. Further described is a footwear article with such a substructure and a machine for the implementation of the method and for the production of the footwear article.

In one possible embodiment, the method includes the steps of pressing the mass positioned and heated on the lower, adhesion-promoting layer with the lower, adhesion-promoting layer to form the inner half-shell and the foaming or injection molding of the lower sole section, without prior demolding of the half-shell in a mold part, wherein a pressing unit is used to press the mass with the lower, adhesion-promoting layer, a press plunger is introduced into the mold part for pressing the compound with the lower, adhesion-promoting layer, a mold cavity is then placed sealingly on the mold part after removal of the press plunger in such a way that a cavity in the form of the sole region remains between the lower, adhesion-promoting layer and the mold cavity, a plastic is then injected or foamed into the cavity, and the substructure is subsequently demolded after the mold part and mold cavity have been moved apart.

Due to the improved process, it is now possible to dispense with process steps that were previously carried out manually. In particular, the use of a suitable adhesion-promoting layer means that the substructure can now be produced entirely using a new machine created for this purpose. Preferably, therefore, no adhesive is used as an adhesion-promoting layer, but a layer made of a fibrous material, such as a natural material, can be used in order to meet the high ecological requirements of high-quality footwear. This layer can be, for example, a layer made of a jute material, which can be produced as a woven or knitted fabric from individual jute threads or fibres. Of course, other natural fibres or synthetic fibres can also be used.

The intermediate layer can be produced from a breathable natural or near-natural material. This can be, for example, a mixture of cork and an ethylene vinyl acetate (EVA). A mixture of cork and a synthetic rubber or caoutchouc can also be used. Another natural material can also be used instead of cork. This mixture is processed as a warm mass. Whereas previously the associated mold in which the mixture was pressed into shape was filled manually, the method according to the disclosure now allows this to be done mechan-ically. An extruder can be used for this purpose, via which the mixture can be produced on the one hand and can also be introduced into the mold part for the production of the intermediate layer on the other.

First, however, if this method is used, a cover is inserted into a receiving cavity of the mold part with the later visible side facing downwards. The hot material of the compound for the production of the intermediate layer is then applied to this cover, which may already be cut to the later parameters of the substructure or may also overlap laterally. This can be distributed evenly or in the required thickness distribution over the length and width of the intermediate layer when it is placed in the receiving mold. If the compound is extruded into the receiving mold, the material can be introduced into the receiving mold via an extruder immediately after plasticizing. For this purpose, the machine can be embodied in such a way that it temporarily feeds the receiving trough and/or the extruder or its outlet nozzle towards each other.

After the hot mass has either been introduced into the receiving mold with the desired thickness distribution or subsequently distributed in the receiving mold, the lower, adhesion-promoting layer is now applied. This layer structure is then pressed into the substructure using a press plunger. However, this is now preferably not demolded, but instead the press plunger is removed and instead of the press plunger a mold cavity is positioned above the receiving cavity in order to constitute an injection mold comprising an inner cavity on the bottom side of which the substructure just produced lies with the adhesion-promoting layer aligned upwards. As a result of the manufacturing process, the adhesion-promoting layer is firmly bonded to the intermediate layer due to the penetration of the material of the mass of the intermediate layer into the fibres and the structure of the layer.

After the injection mold with the inserted base has been closed in the manner described above, the plastic of the lower sole section loaded with blowing agent is now injected into the cavity. The outer, stable edge areas are produced by cooling the side walls of the mold cavity, which in turn prevents foaming in the edge area. At the same time, this plastic also interlocks positively with the adhesion-promoting layer, so that the use of adhe-sives can be dispensed with and a significantly more stable bond between the substructure and the lower sole section can still be achieved. After the lower shoe part produced in this way has cooled, it can then be demolded and joined to the upper shoe part.

Alternatively, an upper shoe part can also be joined to the substructure or the lower sole section directly during the injection molding of the lower sole section or even during the production of the substructure. For this purpose, the upper shoe part is inserted into the receiving mold and fixed either by the mass of the substructure's intermediate layer or by the plastic of the lower sole section.

In a further embodiment, the cover of the substructure is punched to the required shape before being inserted into the receiving mold. This punch can also be used to stamp information onto the cover at the same time, for example the manufacturer's name, the model of the footwear or the parameters of the footwear. This saves an additional step of printing on the cover.

Finally, it may also be desirable for the adhesion-promoting layer to also cover the outer area of the intermediate layer. In this case, the adhesion-promoting layer can first be inserted into the receiving cavity, which is then coated with the mass and, if necessary, the cover. To cover the edges over the adhesion-promoting layer, it is placed in the mold so that it protrudes upwards at the sides in the edge area. The substructure thus formed is then pressed as described above. In this embodiment, of course, the adhesion-promoting layer now lies on the bottom side of the receiving mold.

In order to be able to inject the plastic of the lower sole section onto the bottom side of the adhesion-promoting layer in this embodiment as well, the mold with the receiving mold can be rotated, for example, whereby a part of the press plunger can remain in the receiving mold to maintain the shape of the substructure. At the same time, an originally lower support of the mold is replaced by the mold cavity, so that the cavity for injecting the plastic material of the lower sole section is now formed above the adhesion-promoting layer.

### BRIEF SUMMARY OF THE DRAWINGS

Further features and advantages of the disclosure are mentioned in the following description of preferred embodiments with reference to the drawings.

In the drawings:

FIG. 1 is a schematic of an assembly of the substructure of an article of footwear in an exploded view;

FIG. 2 shows the substructure according to FIG. 1 in an assembled state,

FIG. 3 is a schematic view of a machine for the implementation of the method according to the disclosure for the production of the substructure of a footwear article according to the disclosure; and

FIG. 4 is a schematic view of a machine according to the disclosure for carrying out the method according to the disclosure.

### DESCRIPTION WITH REFERENCE TO THE DRAWINGS

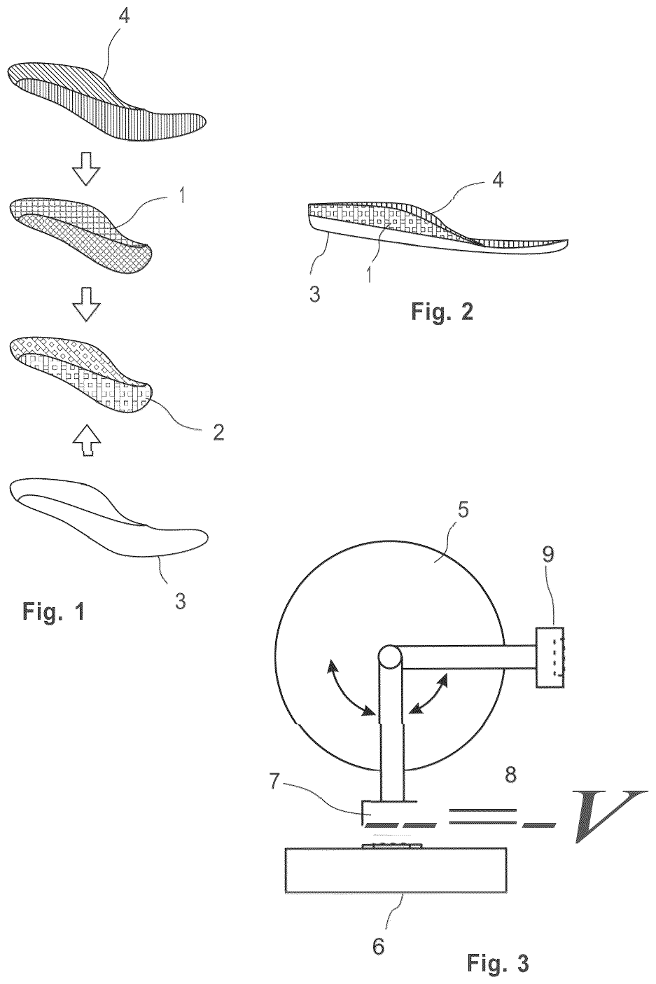

FIG. 1 shows a schematic exploded view of the structure of a substructure of an article of footwear. The arrows shown symbolize one possible sequence in which the individual layers are constructed. The uppermost layer is a cover 4, for example a cover 4 made of microfibre or another fabric material.

The intermediate layer 1, which can be produced from a material mixture of cork and EVA, lies underneath the cover 4. The lower sole section 3 is shown below, which is later injection molded onto the bottom side of the adhesion-promoting layer 2 after the upper three layers, namely cover 4, intermediate layer 1 and lower, adhesion-promoting layer 2, have been joined together.

The adhesion-promoting layer 2 can be made of a porous, rather coarse or coarse-meshed material into which the plastic of the lower sole section 3 and the intermediate layer 1 can at least partially diffuse. Furthermore, the layer 2 can additionally or alternatively be formed by a woven, braided or knitted fabric made of individual fibers, so that the material of the intermediate layer 1 and/or the lower sole section 3 can also me-chanically grip around regions of the lower, adhesion-promoting layer 2. In this way, the four layers shown in FIG. 1 are firmly bonded, which is shown in FIG. 2 as a combination of the substructure with the lower sole section 3.

FIG. 3, in turn, schematically shows part of a possible machine for the production of the part of the footwear shown in FIGS. 1 and 2. The machine comprises a workpiece carrier 6, on the upper side of which a mold part 8 with a receiving mold is provided, into which the layers of the substructure, namely the cover 4, the mass for producing the intermediate layer 1 and the adhesion-promoting layer 2 are inserted.

After these components have been inserted, a press plunger 7 is lowered into the recess and presses the components into the substructure. The press plunger is then raised again and moved out of the region of the receiving mold of the mold part 8. The mold cavity 9 of another tool is then positioned above the mold part 8, whereby the mold cavity 9 is placed on the receiving cavity of the mold part 8 in such a way that, together with the receiving cavity, it forms a closed injection mold, in the lower region of which the previously produced substructure is located. The material of the lower sole section 3 can now be injected into the cavity located above the substructure by means of an injection molding func-tion (not shown), so that a lower sole section made of plastic integrally bonded to the substructure is produced.

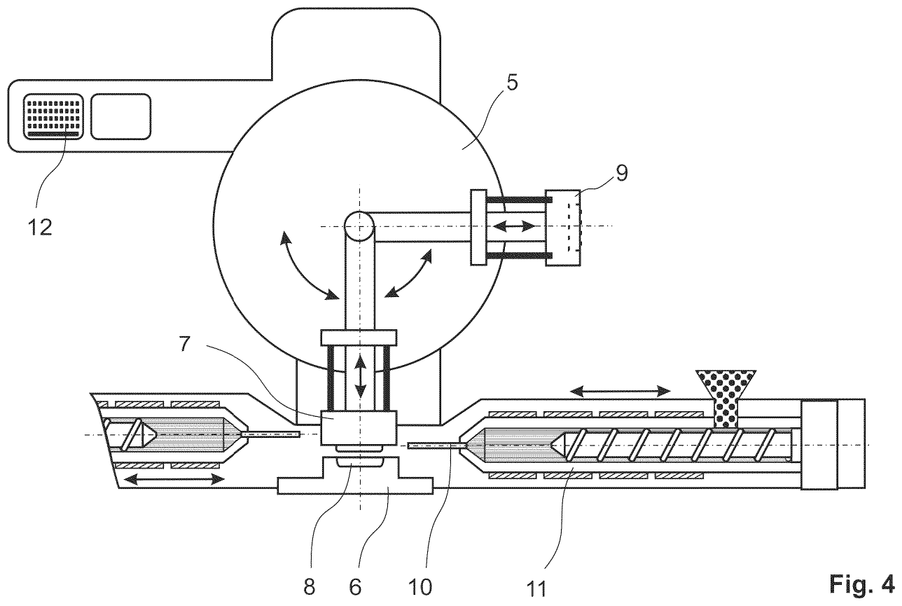

FIG. 4 shows a schematic view of an exemplary machine with which the method according to the disclosure can be implemented. The machine comprises a plurality of injection molding components 11, in this case two, which are shown here as a screw extruder with an external heating device. The mass of the starting material is first introduced into the mold part 8 via the first injection molding component 11 shown on the right. As illustrated, the entire screw extruder is movable for this purpose, so that the sprue channel 10 can be accessed via the mold part 8, so that the mass heated by friction and the external heating device can be extruded out into the mold. However, this is only a very simplified representation of a possible solution; the injection molding component 11 could just as well be fixed and the sprue 10 embodied as movable. The only important thing is that the machine is able to heat the mass and convey the heated mass into the mold part 8 when the mold is open.

After the mass has been heated, it is positioned in the inner half-shell in order to then press the lower, adhesion-promoting layer 2 inserted into the mold with the mass to form the inner half-shell. The lower sole section 3 is then foamed or injection-molded. This can also be done using an injection molding component 11. According to the disclosure, the mold is now changed before demolding the inner half-shell in order to be able to produce the lower sole section 3 in the mold used without first demolding the inner half-shell. For this purpose, the inner half-shell is first produced in such a way that the later bottom side is on top. By changing the mold, a mold cavity 9 with the cavity open at the bottom is now moved over the inner half-shell and lowered so that a closed cavity is created with the inner half-shell on its bottom side.

After closing the mold by lowering the mold cavity 9, the lower sole section 3 is then molded directly onto the inner half-shell by injecting or foaming. In the example shown, the tools for providing the upper half of the mold cavities are provided rotatably on the carrier 5. Of course, all other mold change options are also possible, in particular transverse dis-placement or a solution using robot technology. The illustration shown is only intended to illustrate the changing of the upper half of the mold and the positioning of the mold cavity on the lower part of the mold, without restricting the type of positioning to the solution shown.

In the embodiment shown, a second injection molding component 11 is provided in order to introduce the material of the subsequent lower sole section 3 into the mold cavity or to press it onto the inner half-shell before the mold cavity is lowered. This technique is particularly suitable for foaming, so that the material can be applied first and foaming can take place after the mold is closed. Of course, the mold cavity could also be lowered first via corresponding connections and then the injection molding component 11 positioned so that the sprue 10 can be connected to the cavity, which can be done automatically when the injection molding component 11 is moved.

Alternatively, the cavity can also be fed directly via an appropriate pipe system, such as with heated pipes. For example, the injection molding component 11 shown on the right in FIG. 4 could also have the mass injected through a sprue channel that runs through the workpiece carrier 6 into the cavity for the mold part 8 located therein. The same applies to the injection molding component 11 shown on the left, which injects the material of the lower sole section 3. As the 45° angle of rotation shown here is not necessary and the molds only need to be moved far enough to allow the other mold to be lowered onto the workpiece carrier 6, one of the two injection molding components 11 or both injection molding components 11 can be connected to the moving parts of the mold via a line system so that the respective mass can also be injected via the suction channels located in the mold.

Finally, the mold cavity 9 could also be arranged on the movably supported injection molding component 11 for injecting the material of the lower sole section 3. In this case, the injection molding component 11 and the mold cavity 9 would move together and the sprue 11 could permanently connect the two structural members to each other. In this case, the two structural members would then be arranged on a movable slide, with the mold cavity 9 positioned in such a way that it can be lowered by the movement of the slide or a lowering device located on the slide after positioning above the workpiece carrier 6 to form a closed cavity.

The machine shown here comprises a control 12 which can be used to make the necessary settings. This is also only shown schematically here. Of course, a decentral-ised control system can also be used instead of a control system close to the machine, whereby the input of user commands is usually not necessary once the machine has been set up. After the lower sole section 3 has been molded onto the inner half-shell, the mold opens again and the substructure can be removed so that it can be further processed into a finished shoe. Connections for the upper part of the shoe can be integrated into the lower sole area at the same time in the process described.

### TABLE OF REFERENCE NUMBERS

1 Intermediate layer
2 Lower, adhesion-promoting layer
3 Lower sole section
4 Cover
5 Carrier
6 Workpiece carrier
7 Press plunger or molding die
8 Mold part
9 Mold cavity
10 Sprue channel
11 Injection molding component
12 Control system

1-15. (canceled)

16. A method for the production of a substructure for footwear, comprising: producing an inner half-shell comprising an intermediate layer forming a foot support and a lower, adhesion-promoting layer by:
heating a mass as a starting material for forming the intermediate layer;
without prior demolding of the mass from a mold part, introducing a press plunger into the mold to press the mass with the lower, adhesion-promoting layer, wherein the heated mass is positioned under the lower, adhesion-promoting layer to form the inner half-shell;
removing the press plunger from the mold and then placing a mold cavity sealingly on the mold part in such a way that a cavity in a form of a sole region remains between the lower, adhesion-promoting layer and the mold cavity; and
cooling the inner half-shell;
without prior demolding of the half-shell from the mold part, forming the substructure by foaming or injection molding a plastic material into the cavity in the form of the sole region to form the inner half-shell on a side of the lower, adhesion-promoting layer; and
then moving the mold part and the mold cavity apart and demolding the substructure.

17. The method of claim 16, wherein a layer of a fibrous material is used as the lower, adhesion-promoting layer, wherein the layer of the fibrous material is a woven or knitted fabric of individual threads or fibers.

18. The method of claim 16, wherein, when pressing the heated mass with the lower, adhesion-promoting layer, a microfibre covering is applied to a side of the intermediate layer facing away from the lower, adhesion-promoting layer.

19. The method of claim 16, wherein the lower, adhesion-promoting layer is trimmed before insertion into the mold cavity and/or after the demolding of the substructure.

20. The method of claim 16, wherein the inner half-shell is shaped during the pressing in such a way that its side facing away from the lower, adhesion-promoting layer comprises the shape of a footbed.

21. The method of claim 16, wherein the mass used as the starting material for forming the intermediate layer is a mixture of a natural material and a synthetic material.

22. The method of claim 16, wherein the lower sole section is produced from polyurethane.

23. The method of claim 16, wherein the intermediate layer and the lower sole section are bonded to one another exclusively via the lower, adhesion-promoting layer and an interlocking of the intermediate layer, the lower, adhesion-promoting layer, and the lower sole section without the use of a chemical adhesion promoter.

24. A substructure for footwear with a sole arranged under the substructure, the substructure comprising:
an inner half-shell including an intermediate layer directly or indirectly forming a foot support, and a lower, adhesion-promoting layer;
wherein the intermediate layer is formed by molding a hot mass, pressing the heated mass positioned on the lower, adhesion-promoting layer with the lower, adhesion-promoting layer to form the inner half-shell and subsequent cooling of the inner half-shell, the sole forming a ground contact surface is foamed or injection-molded onto the substructure;
wherein the lower, adhesion-promoting layer is a layer of a fibrous material that is bonded to the substructure and the lower sole section without additional adhesive by pressing in the heated mass during the production of the substructure and by foaming or injection-molding the lower sole section.

25. The substructure for footwear of claim 24, wherein, on a side of the intermediate layer facing away from the lower, adhesion-promoting layer, a cover made of a microfiber is applied and is bonded to the intermediate layer without adhesive by pressing on the warm mass during production of the substructure.

26. A machine for production of a substructure of footwear, comprising:
a pressing device combined with an injection molding machine;
at least one workpiece holder in the form of a mold part with a receiving mold in the form of the substructure of footwear;
at least one press plunger moveable into the receiving mold of the mold part for pressing a mass located in the receiving mold with a lower, adhesion-promoting layer positioned below the mass; and
a mold cavity that is displaceable via the workpiece holder, wherein the mold cavity is placeable on the molded part via the machine such that, with the exception of one or more sprue channels, a closed mold is formed above the substructure; and
an injection molding component configured for injecting plastic material into the cavity via one or more cast-in channels.

27. The machine of claim 26, wherein the mold part is fixedly arranged on a workpiece carrier, wherein the press plunger and the mold cavity are movably supported on the machine via a control and can be adjusted to the molded part one after the other by moving the press plunger and the mold cavity and/or the molded part.

28. The machine of claim 27,
wherein the press plunger and the mold cavity are mounted on a displaceable, carrier;
wherein for positioning the pressing plunger, the carrier is displaceable such that the pressing plunger is arranged above the molded part and, for pressing the substructure in the receiving mold of the molded part, either the carrier or the pressing plunger is moveable with a pressing section in the direction of the receiving mold or the receiving mold arranged on a movable structural member of the machine can be positioned against the pressing plunger;
wherein, for closing the injection mold, the carrier is displaceable such that the mold cavity is arranged above the receiving cavity and, for the production of a lower sole section in the cavity between the receiving cavity and the mold cavity, either the carrier or the mold cavity movable on the carrier can be moved in a direction of the receiving mold or the receiving cavity arranged on a movable region can be adjusted against the mold cavity for closing the cavity.

29. The machine of claim 26, comprising a screw extruder arranged to convey a heated mass for the production of the substructure onto the lower, adhesion-promoting layer, and for injecting plastic for the production of the lower sole section into the cavity.
